(19) United States
(12) Patent Application Publication
(10) Pub. No.: US 2017/0023747 A1
(43) Pub. Date: Jan. 26, 2017

(54) EYE-SAFE INTERFACE FOR OPTICAL CONNECTOR

(71) Applicant: Samtec, Inc., New Albany, IN (US)

(72) Inventor: Eric Jean ZBINDEN, Sunnyvale, CA (US)

(21) Appl. No.: 14/803,386

(22) Filed: Jul. 20, 2015

(51) Int. Cl. G02B 6/38

(52) U.S. Cl. CPC G02B 6/3853; G02B 6/383; G02B 6/3851; G02B 6/3882; G02B 6/3885

(57) ABSTRACT

An optical connection includes a first lens with a first strength, a second lens with a second strength weaker than the first strength, a gap between the first lens and the second lenses, and optical fibers that are connected to the first and second lenses and that provide or receive light from the first and second lenses. No intermediate image is formed, and a beam of light in the gap region is either diverging or converging.

### BACKGROUND OF THE INVENTION

1. Field of the Invention

The present invention relates to optical connectors. More specifically, the present invention relates to an eye-safe interface for optical connectors.

2. Description of the Related Art

Some optical connectors, such as MPO and MTP connectors, use fiber-to-fiber contact to transmit light from one fiber to another. Fiber-to-fiber contact requires that the end surface of each connector be carefully polished and kept clean. Even small dust particles can greatly increase the insertion loss and cause unwanted Fabry-Perot reflection. The tight tolerances and the required polishing increase the cost of such fiber-to-fiber connectors.

In data com optical links, the MTP connector can be one of the most expensive components.

The light exiting an MPO or MTP connector diverges per the numerical aperture (NA) of the optical fiber. The diverging light typically does not cause an eye safety issue because the optical power density of the exiting light decreases according to the square of the distance. However, new connectors, such as PRIZM-MT by USConec, use collimated beams of light, which can cause serious eye safety issues as such a beam remains at a high intensity over long distances. Such collimated-beam connectors use a symmetrical lens system to create collimated beams that exit the connectors. With collimated-beam connectors, the fibers can be cleaved without being polished, which reduces cost. The collimated beam makes it easier to mate two connectors because the size of the cross section of the collimated beam is large compared to the size of cross section of the light in the core of an optical fiber. The larger beam size reduces the lateral, i.e. perpendicular to the beam propagation direction, mating tolerances required to mate two collimated-beam connectors, although the angular tolerances will be reduced. In addition, the collimated-beam connectors are less susceptible to dust and contamination because the larger beam size at the connector interface results in less light being obscured by a given-size dust particle on the interface between the two connectors.

The main drawbacks of collimated-beam connectors are eye-safety issues caused by the collimated beams. In a collimated beam, the amount that the optical power density decreases with distance is small. The collimated beam is not a problem when the light is transmitted directly from one connector to another connector. However, the collimated beam can be a serious eye-safety problem when the connector is not connected to another connector, and the collimated beam is transmitted into free space where it can enter the eye of a nearby person. Passing laser eye-safety requirements can be much more challenging with collimated-beam connectors because the full power or almost full power of the light can enter a person's eye at large distances from the connector, which can damage the eye. This can limit the allowable power transmitted down an optical link, which decreases link margin and can increase overall system costs. Link margin is the amount of loss a link can tolerate and still function properly. For example, if a transmitter transmits −1 dBm of power and if the receiver requires at least −10 dBm of power to function properly, then 9 dB of power loss between the transmitter and the receiver can be tolerated.

U.S. Pat. No. 8,457,458 proposes a connection system using converging, rather than collimated, beams between mating connectors. A single lens forms the converging beam, creating an image of the source in an air gap between the mating connectors. Light transmission is achieved by using two identical connectors placed so that their image points coincide. This system requires a relatively large gap region between the connectors to allow sufficient beam propagation length for the beam to symmetrically expand about its coincident image points. This increases the overall length of the optical connection.

Alternatively, an end surface of a fiber can be positioned at the image point of the first connector. However, this system is still sensitive to contamination because the beam size is small at the edge of the gap region where the beam enter/exits the end surface of the fiber. It also requires an expensive, polished connector interface for the end surface of the fiber.

Accordingly, the inventors of the preferred embodiments of the present invention described below recognized that it would be advantageous to provide a low-cost connector, which is eye-safe, contamination resistant, and provides relaxed mechanical alignment tolerances.

### SUMMARY OF THE INVENTION

To overcome the problems described above, preferred embodiments of the present invention provide an optical interface with a non-symmetrical lens system so that the light exiting the optical interface is not collimated, which improves eye safety and so that beam sizes at the optical interface are large compared to the size of the fibers in the optical interface, which allows the optical interface to be less sensitive to contamination.

An optical connection according to a preferred embodiment of the present includes a first lens with a first strength, a second lens with a second strength weaker than the first strength, a gap between the first lens and second lens, and optical fibers that are connected to the first and second lenses and that provide or receive light from the first and second lenses. No intermediate image is formed, and a beam of light in the gap region is either diverging or converging.

The second strength is preferably zero.

The optical connection further preferably includes additional first lenses with the first strength and additional second lenses with the second strength. The first lens, the additional first lenses, the second lens, and the additional second lenses are preferably arranged in at least one annular ring.

The first lens, the additional first lenses, the second lens, and the additional second lenses are preferably arranged in at least one row. The first lens, the additional first lenses, the second lens, and the additional second lenses are preferably arranged such that lenses with different strengths alternate along the at least one row.

Preferably, the first lens and the additional first lenses are arranged in a first array, and the second lens and the additional second lenses are arranged in a second array adjacent to the first array. The first lens, the additional first lenses, the second lens, and the additional second lenses are preferably arranged such that each optical path through the optical connection includes a lens with the first strength and a lens with the second strength.

An optical connection according to a preferred embodiment of the present invention includes a first ferrule including a first lens, a first fiber attached to a first ferrule, a second ferrule including a second lens, and a second fiber attached to the second ferrule. The first and second ferrules, the first and second lenses, and the first and second fibers are configured to provide a first channel that defines a light transmission path, and an optical power of the first lens is different than an optical power of the second lens.

Preferably, light emerging from the first fiber is not collimated by the first lens, and light emerging from the second fiber is not collimated by the second lens. A gap between the first lens and the second lens preferably is less than about 100 μm.

The optical connection further preferably includes a third fiber attached to the first ferrule and a fourth fiber attached to the second ferrule. The first ferrule further preferably includes an additional second lens, and the second ferrule further includes an additional first lens. The first ferrule and the second ferrule are preferably identical or substantially identical. The first and second ferrules, the additional first and second lenses, and the third and fourth fibers are preferably configured to provide a second channel that defines another light transmission path. The optical connection further preferably includes keyed, hermaphroditic alignment elements such that the first ferrule and the second ferrule can only be mated in one orientation. The optical connection further preferably includes additional channels, where each of the additional channels includes lenses of different strengths.

The optical connection further preferably includes a gap between the first ferrule and the second ferrule. An optical signal propagating across the gap preferably has a beam diameter of at least about 100 μm at an end surface of the first ferrule and at an end surface of the second ferrule, and the beam diameter preferably varies across the gap.

A first side of an optical interface according to a preferred embodiment of the present invention includes first lenses with a first strength, second lenses with a second strength weaker than the first strength, and optical fibers that are connected to the first and second lenses and that provide or receive light from the first and second lenses. The first lenses and the second lenses are arranged in a hermaphroditic pattern.

The first side preferably includes a ferrule supporting the optical fibers. The ferrule supporting the optical fibers preferably includes hermaphroditic alignment features. The first lenses and the second lenses are preferably formed in the ferrule.

When the first side is rotated by about an axis parallel to a mating direction of the first side, a pattern of the first and second lenses is preferably reversed with a second lens in a location formerly occupied by a first lens and a first lens in a location formerly occupied by a second lens. The rotation is preferably 180°.

An optical connection according to a preferred embodiment of the present invention includes a first side of an optical interface according to another preferred embodiment of the present invention, and a second side of the optical interface identical or substantially identical to the first side of the optical interface. The first and the second sides of the optical interface are mated together.

An optical connector according to a preferred embodiment of the present invention includes a first side of an optical interface according to another preferred embodiment. The ferrule supporting the optical fibers preferably includes hermaphroditic alignment features. The first lenses and the second lenses are preferably formed in the ferrule.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 shows an example of an optical connector that can be used with a ferrule according to the preferred embodiments of the present invention.

FIG. 2 is a perspective view of a ferrule according to a preferred embodiment of the present invention.

FIG. 3 is a see-through, perspective view of a ferrule according to a preferred embodiment of the present invention.

FIG. 4 is a perspective view of the ferrules in FIGS. 2 and 3 before being mated.

FIG. 5 is a close-up view of light exiting a ferrule through a strong lens and a weak lens.

FIG. 6 is a close-up view of light exiting a ferrule having both strong and weak lenses according to a preferred embodiment of the present invention.

FIG. 7 is a close-up view of the mated ferrules according to a preferred embodiment of the present invention.

FIG. 8A shows a prior art butt-coupled optical connection.

FIG. 8B shows a prior art optical connection with a collimated beam and symmetric lenses.

FIG. 8C shows a prior art optical connection with a converging beam and symmetric lenses.

FIG. 8D shows a prior art optical connection with a converging beam and a single lens.

FIG. 8E shows an optical connection with a strong and weak lens according to a preferred embodiment of the present invention.

FIG. 8F shows an optical connection with a strong and weak lens where the weak lens has zero optical power according to a preferred embodiment of the present invention.

FIG. 9A shows an optical interface with alternating rows of strong and weak lenses according to a preferred embodiment of the present invention.

FIG. 9B shows an optical interface with alternating strong and weak lenses with a row according to a preferred embodiment of the present invention.

FIG. 9C shows an optical interface with alternating strong and weak lenses arranged in an annular ring according to a preferred embodiment of the present invention.

### DETAILED DESCRIPTION OF PREFERRED EMBODIMENTS

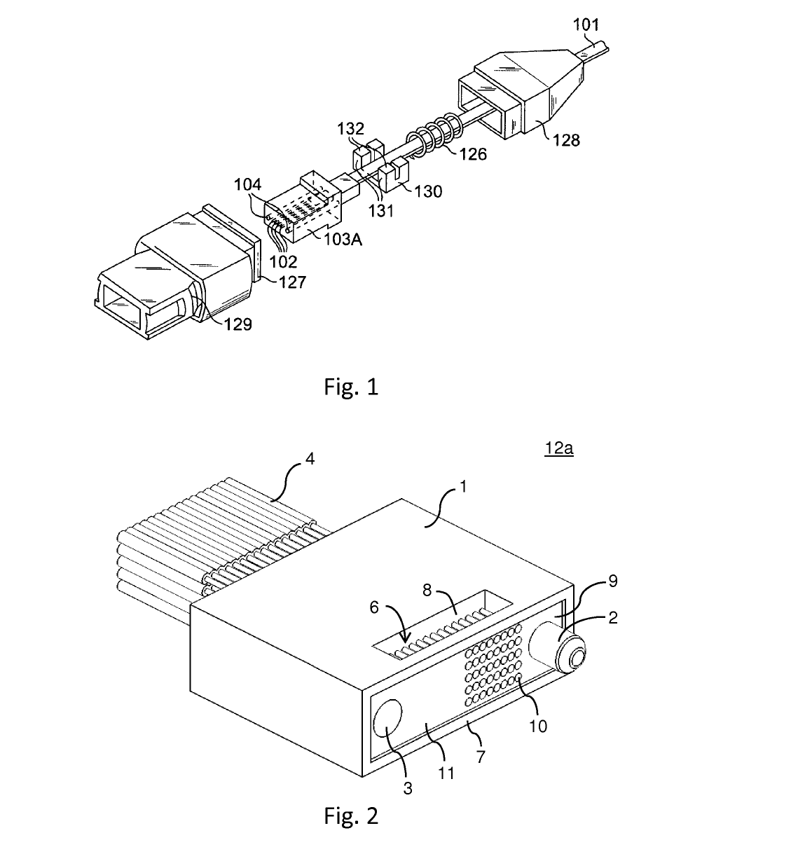

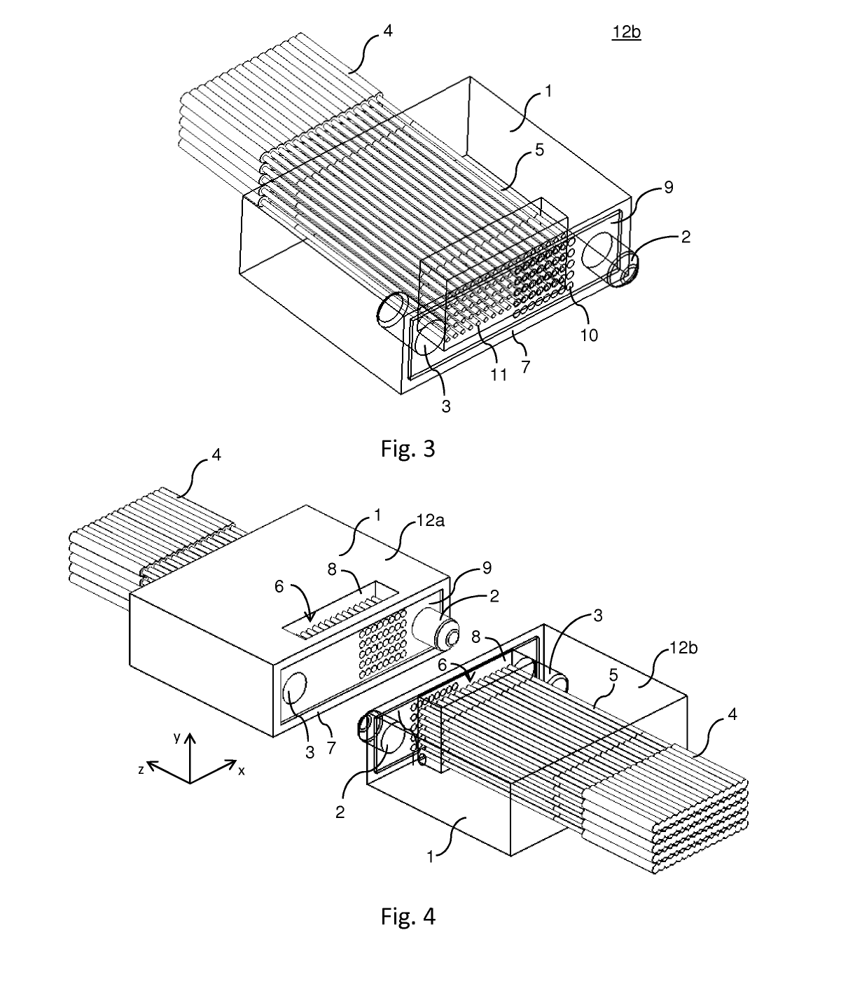

Preferred embodiments of the present are directed to an optical interface. This optical interface can be implemented as a ferrule. FIG. 1 in this application is the same as FIG. 1 of U.S. Pat. No. 7,156,561. FIG. 1 shows an example of an optical connector in which a ferrule according to preferred embodiments of the present invention can be used. The MT-type connector in FIG. 1 includes a ferrule 103A that provides a housing for the fibers 102 projecting out of the end of the ribbon 101 and that includes a pair of guide-pin insertion holes 104. The ferrules 12a, 12b shown in FIGS. 2-7 can be used as ferrule 103A in FIG. 1. A guide-pin holding member 130 behind the ferrule 103A holds the guide pins inserted into the guide-pin insertion holes 104 to prevent the guide pins from extending behind the ferrule 103A. The guide-pin holding member 130 has guide-pin holding holes 131 having inner diameters slightly smaller than those of the guide pins and having slits 132 that split the upper portions of the circumferences of the guide pin holding holes 131. A spring 126 is provided behind the guide-pin holding member 130 to press the ferrule 103A against another ferrule (not shown). A front housing 127 and a rear housing 128 house the ferrule 103A, the guide-pin holding member 130, and the spring 126. The front housing 127 includes a groove 129 that can engage with a locking member of a corresponding mating connector (not shown).

Although the description below focuses on the optical interface, and particularly on the ferrule portion of a connector, it should be understood that the optical interface according to preferred embodiments of the present invention is compatible with other suitable connectors. For example, the optical interface according to preferred embodiments of the present invention can be used with an MPO connector because the optical interface can be made to be compatible with an MT ferrule footprint. The optical interface can also be used with custom components.

The optical interface according to preferred embodiments of the present invention provides channels that define transmission paths for light, which typically includes optical fibers and a lens system. The optical interface includes a molded element (e.g., a ferrule) which mechanically supports and positions the fibers.

The ferrule can be a keyed, hermaphroditic molded element (e.g., a hermaphroditic ferrule). A hermaphroditic element is a genderless element that is neither male nor female. A hermaphroditic element can be connected to another hermaphroditic element. In a gender system with male and female elements, a male element can be connected to a female element (and vice versa). But a male element cannot be connected to another male element, and a female element cannot be connected to another female element. Many prior art systems use transceivers (i.e., a combined transmitter and receiver) as a male element and fiber-optic patch cords as a female element. This requires a special male/male adapter if two fiber-optic patch cords need to be mated.

A benefit of a hermaphroditic element is that it increases design flexibility. For example, the optical interface can be used with a transmitter, a receiver, or a transceiver on one side of the optical interface and a fiber-optic patch cord on the opposing side of the optical interface. In a genderless system, changing from a receiver to a transmitter does not require changing the optical interface. Also, two fiber-optic patch cords can be directly mated together without a special adapter.

Preferably, the lens system includes transmission channels, i.e., the paths that the light beams take in the lens system. Each channel is arranged such that the light beam goes through exactly one strong lens and one weak lens. The optical power and the positions of the strong lens and the weak lens are preferably designed to optimize performance and to significantly reduce or minimize contamination sensitivity and mechanical tolerances, while providing an eye-safe connector. For connectors using a hermaphroditic ferrule, the ferrule is preferably arranged so that some of the ferrule's channels use strong lenses and some of the ferrule's channels use weak lenses and so that, when two hermaphroditic ferrules are mated, each optical channel has a strong and weak lens. This arrangement can be accomplished by providing a non-symmetrical lens system.

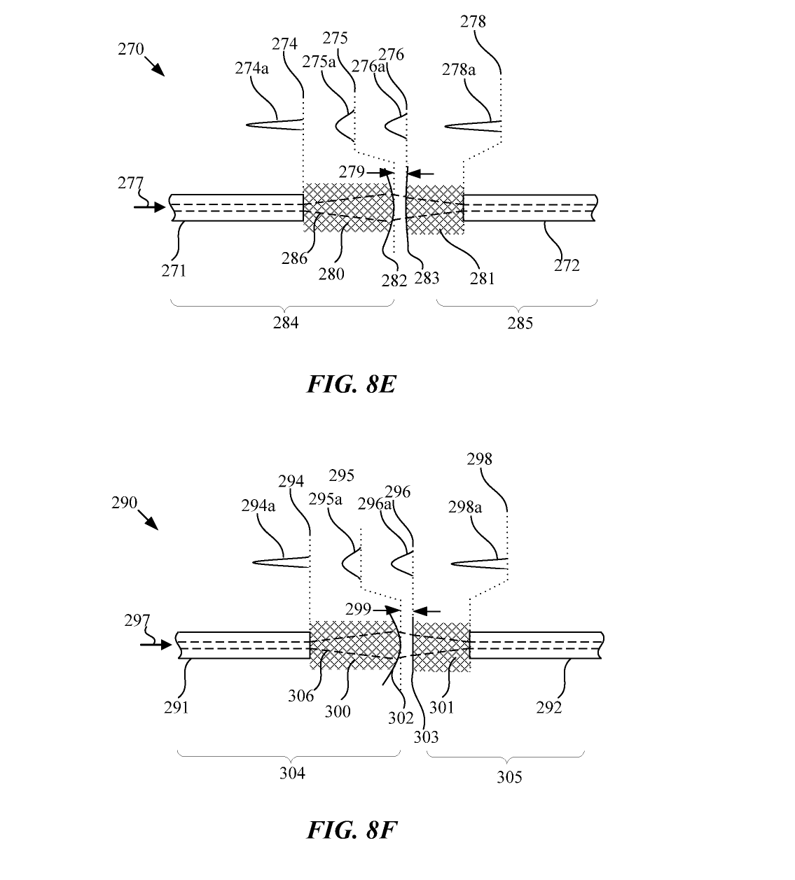

The weak lenses can be zero-power lenses, i.e., a lens with a flat surface. Using zero-power lenses simplifies design and fabrication. Use of a zero-power lens, rather than no lens, increases the beam size at the connector interface, making the interface less sensitive to optical contamination. In this application, “weak lens” include a zero-power lens. FIG. 7 shows two mated optical interfaces, i.e., two ferrules 12a, 12b, with each beam going through exactly one strong lens 10 and one zero-power lens 11. FIG. 7 shows two hermaphroditic ferrules, in which each optical channel has a strong lens 10 and a weak lens 11 but in which the order of the weak lens 11 and the strong lens 10 is switched on the left and right sides.

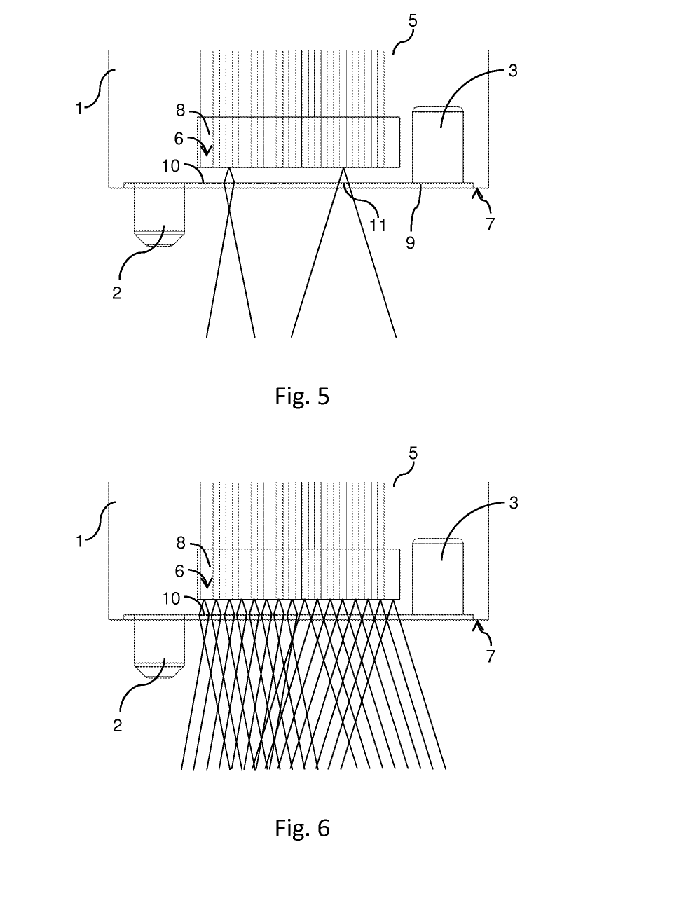

FIGS. 2-7 show the optical interface as ferrules 12a, 12b. FIG. 2 shows a solid ferrule 12a, and FIG. 3 shows a see-through ferrule 12b to show the location of the holes 5.

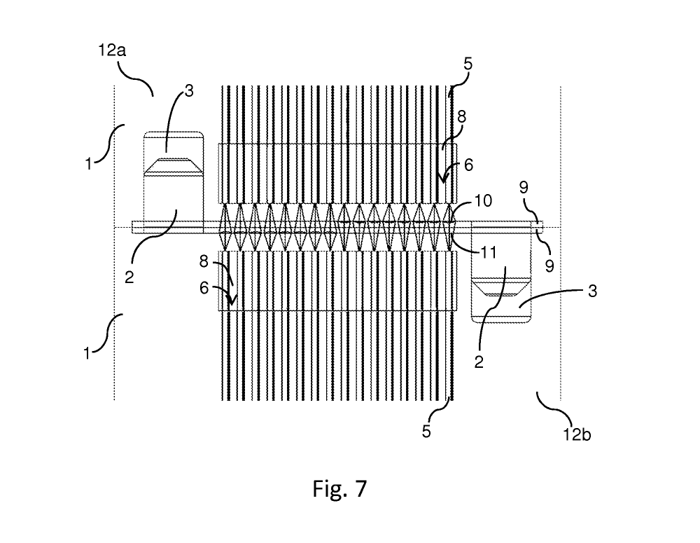

Ferrules 12a, 12b include a ferrule body 1 that is preferably molded. The ferrule body 1 can be formed from any suitable transparent moldable material, such as Ultem or other molded polymers. The ferrule body 1 can include an alignment pin 2 and a corresponding alignment hole 3 that align two ferrules during mating to ensure optical integrity of each of the channels once the two ferrules are mated. FIG. 4 shows the ferrules 12a, 12b as they are being mated along the z-direction, i.e. a direction parallel to the light propagation direction through the ferrules 12a and 12b. The alignment pin 2 of the ferrule 12a is inserted into the alignment hole 3 of the ferrule 12b, and the alignment pin 2 of the ferrule 12b is inserted into the alignment hole 3 of the ferrule 12a. Preferably, the alignment pins 2 are shaped to provide coarse and then fine alignment by having different radiuses along their length. Different alignment features can also be used. For example, different shaped alignment pins 2 and holes 3 can be used.

The ferrule body 1 includes holes 5 in which the fibers 4 are located and includes a cavity 8 through which the fibers 4 extend. The ferrules 12a, 12b shown in FIGS. 2-7 preferably includes 5 rows of 16 fibers for a total 80 optical channels, for example. However, the ferrules 12a, 12b can have any number of channels, including, for example, 1 channel or 4 to 80 channels.

The fibers 4 are preferably arranged in an array with, for example, a 250 μm (or about 250 μm within manufacturing tolerances) pitch in the x- and y-directions defined by the front surface 7 of the ferrule body 1, which allows fiber ribbons to be used. The pitch in the y-direction can be increased to, for example, about 300 μm to about 500 μm, within manufacturing tolerances, to allow slack between the fiber ribbons. Although fiber ribbons are preferably used, it is also possible to use individual fibers.

The fibers 4 are stripped of their coating, cleaved, and then inserted into corresponding holes 5 that precisely align each of the fibers 4 with a strong or weak lens 10 or 11 on the front surface 7 of the ferrule body 1.

A cavity opening 6 behind the front surface 7 allows for epoxy (not shown) to permanently attach the fiber in the ferrule body 1. The fibers 4 guided by the holes 5 are pushed all the way forward until they butt or nearly butt against the end of the cavity 8 with the lens system molded into the front surface 7. The front surface 7 includes a recessed region 9 so that light is transmitted through a gap space defined by the recessed region 9 when the ferrules 12a, 12b are mated, as shown in FIG. 7.

The lens system is preferably non-symmetric by including strong and weak lenses 10, 11. For example, an array of strong lenses 10 can be adjacent to an array of weak lenses 11 as shown in FIGS. 2-7. Preferably, half of the lenses are strong lenses 10, and the other half are weak lenses 11. Preferably each of the strong lenses 10 has the same optical power and position relative to their corresponding fiber within manufacturing tolerances. The focal point of the strong lenses 10 is preferably outside of the ferrule body 1 and is preferably located, when two ferrules are mated, at the surface of the fibers of the opposite ferrule, which transmit the maximum amount of light. The weak lenses 11 are preferably zero-power lenses (i.e., a lens with a flat surface). An advantage of having zero-power lenses as the weak lens is that fabrication of the mold is simplified because additional lens features are not required.

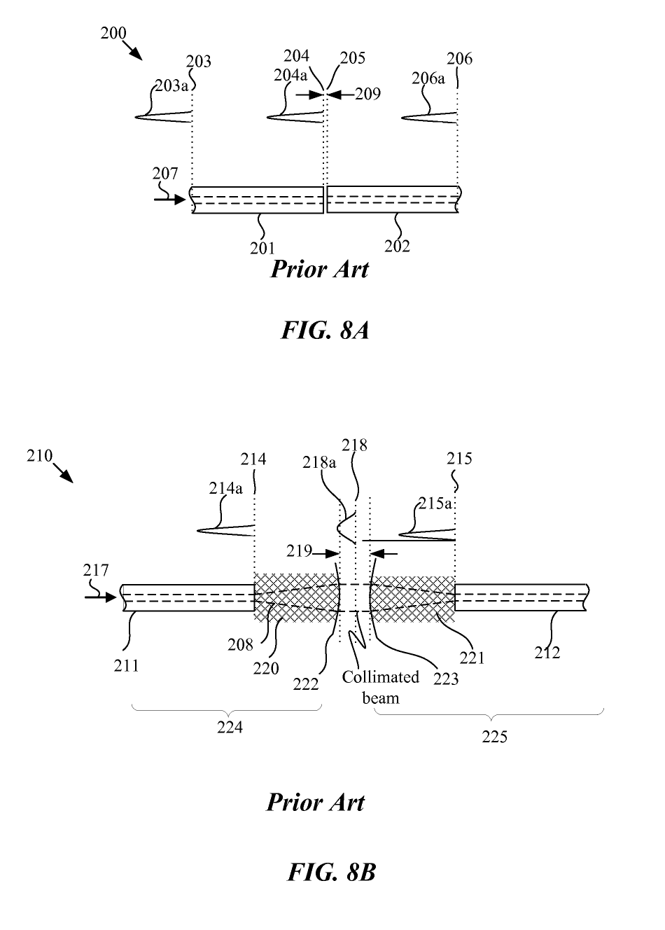

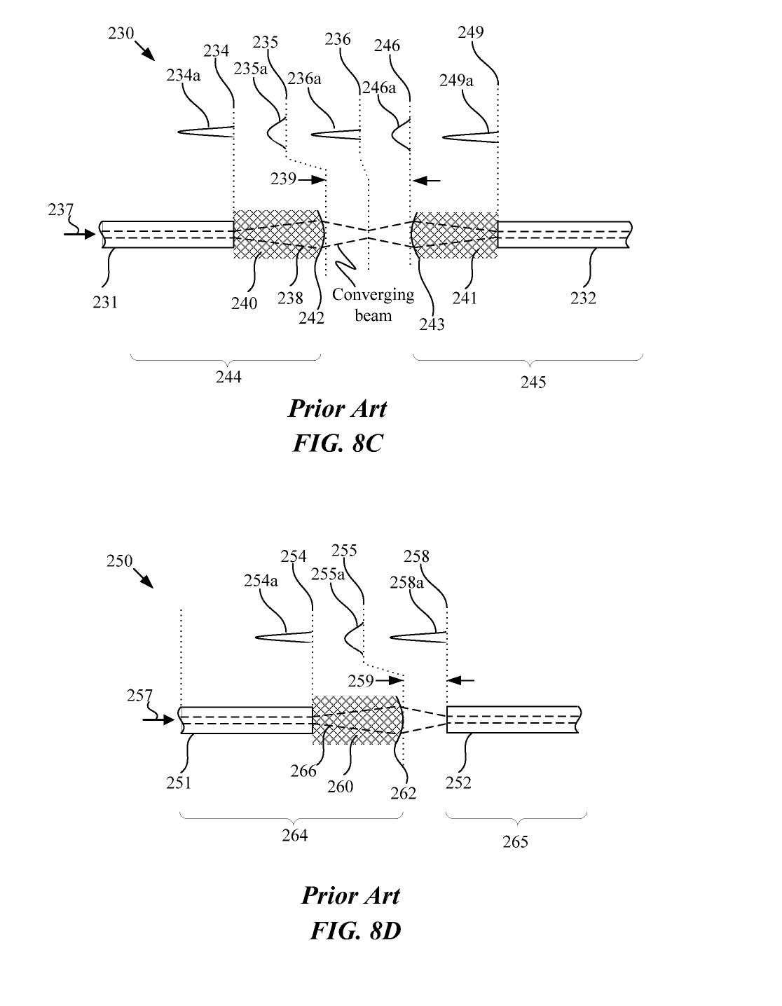

FIG. 5 shows the light transmitted through one strong lens 10 and one weak lens 11, and FIG. 6 shows the light transmitted through each of the strong lenses 10 and each of the weak lenses 11. Both the light through the strong lens 10 and the light through weak lens 11 eventually diverge, which is good for eye safety. If the observer is far away from the source, not all of the light can enter the observer's eye because the beam has diverged and has a large beam diameter. If the observer is close to the source, the divergence of the beam will result in the eye being unable to focus the light on the retina, again providing enhanced eye safety. The light through the strong lens 10 converges at a focal point, and then diverges, while the light through the weak lens 11 diverges when it exits the fiber 4. The divergence of the light through the strong lens 10 and the light through weak lens 11 allows for higher power to be used while maintaining an eye safe environment, which can improve link margin and/or signal integrity.

If the ferrules 12a, 12b are to be used in a bi-directional device with both transmission and receiving, the channels with the strong lenses 10 on one side of the connection can transmit or receive light, while the channels with the weak lenses 11 on the same side of the connection can receive or transmit light.

Preferably the lens system has an equal number of strong lenses 10 and weak lenses 11. Although FIGS. 2-7 show an array of strong lenses 10 arranged adjacent to an array of weak lenses 11, other arrangements are also possible. Any hermaphroditic pattern that allows for a hermaphroditic element can be used. Examples of hermaphroditic patterns include any pattern that, when rotated, reverses the positions of the strong lenses 10 and weak lenses 11. For example, in the pattern shown in FIGS. 2-7, a 180° rotation around the mating direction of the ferrules 12a, 12b results in the strong lenses 10 switching positions with the weak lenses 11.

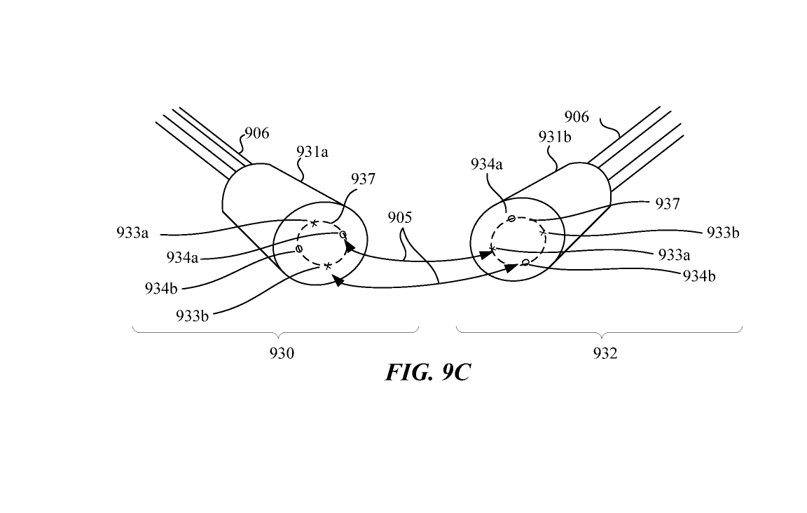

An interleaved pattern could be used in which the strong lenses 10 and the weak lenses 11 alternate rows as shown, for example, in FIG. 9A. The first side 910 of the optical interface preferably has four rows of lenses and has twelve lenses per row, for example. Two of the rows 903a and 903b have weak lenses (denoted with “x”), and two of the rows 904a and 904b have strong lens (denoted with “o”). The rows 903a and 903b of weak lenses and the rows 904a and 904b of strong lenses are formed in a ferrule 901a. Optical fibers 906 are connected to the back of the ferrule 901a and are oriented along a longitudinal axis that is perpendicular or substantially perpendicular to the rows 903a, 903b, 904a, 904b.

The mating second side 912 of the optical interface also preferably has four rows of lenses and twelve lenses per row, for example. Two of the rows 903a and 903b have weak lens, and two of the rows 904a and 904b have strong lens. The rows 903a and 903b of weak lenses and the rows 904a and 904b of strong lenses are formed in a ferrule 901b. Optical fibers 906 are connected to the back of the ferrule 901b and are oriented along a longitudinal axis that is perpendicular or substantially perpendicular to the rows 903a, 903b, 904a, 904b.

When the first side 910 of the optical interface is mated with the second side 912 of the optical interface, each row 903a and 903b of weak lenses mates with a corresponding row 904a and 904b of strong lenses. This mating is illustrated by the arcs 905 that show representative strong and weak lenses that are mated when the optical interface is formed by mating the first side 910 of the optical interface with the second side 912 of the optical interface 912. The first side 910 of the optical interface is identical or substantially identical to the second side 912 of the optical interface, and ferrule 901a is identical or substantially identical to ferrule 901b. Here substantially identical includes identical to within normal manufacturing tolerances and cosmetic differences that do not affect the function of the interface. In FIG. 9A, alignment features are not shown for clarity.

While FIG. 9A shows an optical interface with alternating rows of strong and weak lenses, the lens arrangement can be modified to have alternating columns of strong and weak lenses. A different number of lenses and a different arrangement of lenses can be used. The number of rows can be more or less than four rows. Each row can have more or less than twelve lenses. Any even number of rows having an even number of lenses can be used. Also, the lens arrangement can be arranged in groups. For example, an eight row pattern with two rows of weak lenses alternating with two rows of strong lenses can be used. Using a symmetric pattern of lenses allows the first side 910 of the optical interface 910 and the second side 912 of the optical interface to be invariant when the first side 910 of the optical interface is rotated by 180° about the longitudinal axis defined by the fibers 906.

FIG. 9B shows another preferred embodiment of the present invention in which the strong lenses and weak lenses alternate in any given row or column. The first side 920 of the optical interface preferably has four rows of lenses and twelve lenses per row, for example. All of the rows 923a, 923b, 923c, and 923d are composed of an alternating pattern of weak lenses (denoted with “x”) and strong lens (denoted with “o”). The lens pattern between the adjacent rows alternates such that any interior strong lens is surrounded by four weak lenses and such that any interior weak lens is surrounded by four strong lenses. The rows 923a, 923b, 923c, and 923d of weak and strong lenses are formed in a ferrule 921a. Optical fibers 906 are connected to the back of the ferrule 921a and are oriented along a longitudinal axis that is perpendicular or substantially perpendicular to the rows 923a, 923b, 923c, and 923d.

The mating second side 922 of an optical interface also preferably has four rows of lenses and has twelve lenses per row, for example. All of the rows 923a, 923b, 923c, and 923d are composed of an alternating pattern of weak lenses (denoted with “x”) and strong lens (denoted with “o”). The lens pattern between the adjacent rows alternates such that any interior strong lens is surrounded by four weak lenses and such that any interior weak lens is surrounded by four strong lenses. The rows 923a, 923b, 923c, and 923d of weak and strong lenses are formed in a ferrule 921b. Optical fibers 906 are connected to the back of the ferrule 921b and are oriented along a longitudinal axis that is perpendicular or substantially perpendicular to the rows 923a, 923b, 923c, and 923d.

When the first side 920 of the optical interface is mated with the second side 922 of the optical interface each row 923a, 923b, 923c, and 923d mates with a corresponding row 923d, 923c, 923b, and 923a. This mating is illustrated by the arcs 905 that show representative strong and weak lenses that are mated when the optical interface is formed by mating the first side 920 of an optical interface with the second side 922 of an optical interface. The first side 920 of the optical interface is identical or substantially identical to the second side 922 of the optical interface, and ferrule 921a is identical or substantially identical to ferrule 921b. In FIG. 9B, alignment features are not shown for clarity.

While FIG. 9B shows an optical interface with alternating rows of strong and weak lenses, the lens arrangement can be readily modified. A different number of lenses and a different arrangement of lenses can be used. The number of rows can be more or less than four rows. Each row can have more or less than twelve lenses. Any even number of rows having an even number of lenses can be used. Use of a symmetric pattern of lenses allows the first side 920 of the optical interface and the second side 922 of the optical interface to be invariant when the first side 920 of the optical interface is rotated by 180° about the longitudinal axis defined by the fibers 906.

FIG. 9C shows another preferred embodiment of the present invention in which the strong lenses 934a, 934b and the weak lenses 933a, 933b alternate in an annular ring. The first side 930 of the optical interface preferably has one lens ring 937, for example. The lens ring 937 preferably has four lenses: two weak lenses 933a and 933b (denoted with “x”) and two strong lens 934a and 934b (denoted with “o”), for example. The lens pattern in the lens ring 937 alternates between strong lenses 934a, 934b and weak lenses 933a, 933b. The weak lenses 933a, 933b and the strong lenses 934a, 934b are formed in a ferrule 931a. Fibers 906 are connected to the back of the ferrule 931a and are oriented along a longitudinal axis that is perpendicular or substantially perpendicular to the lens ring 937.

The mating second side 932 of an optical interface also preferably has two weak lenses 933a, 933b and two strong lenses 934a, 934b arranged in an alternating pattern along an lens ring 937, for example. The weak lenses 933a, 933b and strong lenses 934a and 934b are formed in a ferrule 931b. Fibers 906 are connected to the back of the ferrule 931b and are oriented along a longitudinal axis that is perpendicular or substantially perpendicular to the lens ring 937.

When the first side 930 of the optical interface is mated with the second side 932 of the optical interface, the alternating weak lenses 933a, 933b and strong lenses 934a and 934b mate with corresponding strong lenses 934a, 934b and weak lenses 933a and 933b. This mating is illustrated by the arcs 905 that show representative strong lenses 934a, 934b and weak lenses 933a, 934b that are mated when the optical interface is formed by mating the first side 930 of an optical interface with the second side 932 of an optical interface 932. The first side 930 of the optical interface is identical or substantially identical to the second side 932 of the optical interface, and ferrule 931a is identical or substantially identical to ferrule 931b. In FIG. 9C, alignment features are not shown for clarity.

While FIG. 9C shows an optical interface with alternating strong lenses 934a, 934b and weak lenses 933a, 933b, the lens arrangement can be readily modified. A different number of lenses and a different arrangement of lenses can be used. The number of lenses in the lens ring 937 can be more or less than four lenses, and the number of lens ring 937 can be more than one. Any number of lens rings with different diameters can be used. Each lens ring can have a circularly symmetric pattern of alternating strong and weak lenses. Use of a symmetric pattern of lenses allows the first side 930 of an optical interface and the second side 932 of an optical interface to be invariant when the first side of optical interface is rotated about the longitudinal axis defined by the fibers 906. Depending on the angular spacing between the lenses, the amount of rotation required to mate the first and second sides of the optical interface will vary. For the pattern shown in FIG. 9C, a 90° rotation reverses the position of the strong lenses 934a, 934b and weak lenses 933a, 933b.

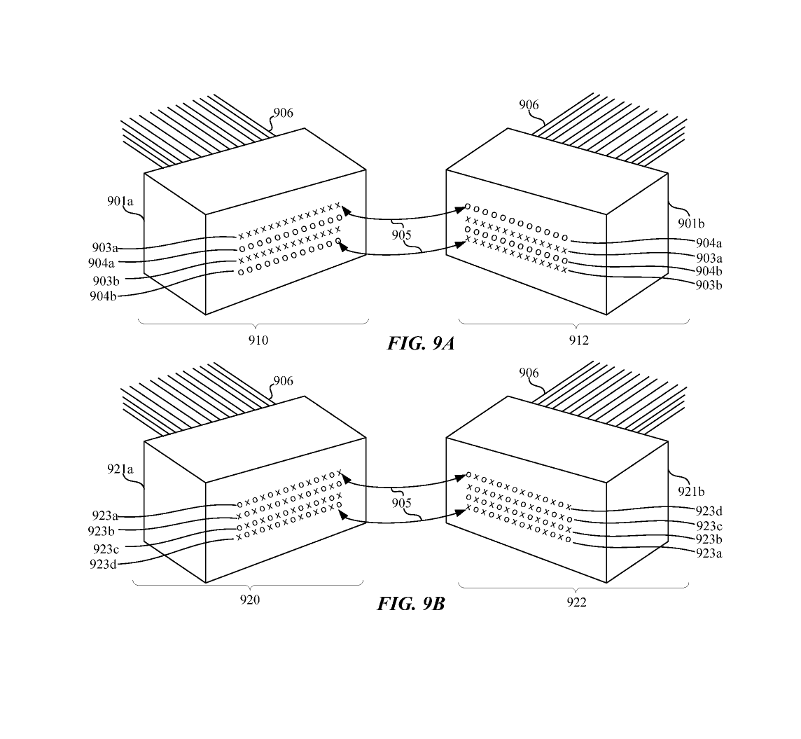

FIG. 8A shows a prior art butt-coupled optical connection 200. The optical connection 200 includes a first fiber 201 and a second fiber 202. The first fiber 201 and second fiber 202 can be a single mode or multimode fiber. Preferably, the first fiber 201 and the second fiber 202 are the same type of fiber. For example, the first fiber 201 and the second fiber 202 can be a SF-28 single-mode fiber or a 0.2 NA, 50-μm-diameter-core multimode fiber. Other fiber types can be used. If the first fiber 201 and the second fiber 202 are of the same type, then the optical connection 200 will function symmetrically independent of the propagation direction of the optical signal 207. Optical signal 207 is shown propagating from the first fiber 201 to the second fiber 202; however, the propagation direction can be reversed.

FIG. 8A shows the beam profiles 203a, 204a, and 206a at longitudinal positions 203, 204, and 206, respectively. Longitudinal position 204 is the end of the first fiber 201 adjacent the second fiber 202. Longitudinal position 205 is the end of the second fiber 202 adjacent the first fiber 201. Beam profiles 203a, 204a, and 206a are substantially similar because the first fiber 201 and the second fiber 202 are substantially identical. The beam profile at longitudinal position 205 is not shown; however, it is substantially similar to the other beam profiles 203a, 204a, and 206a.

FIG. 8A shows a gap 209 between the adjacent ends of the first fiber 201 and the second fiber 202. In practice, this gap is preferably zero and the first fiber 201 and the second fiber 202 physically contact each other. The optical connection 200 has several disadvantages. The coupling efficiency is extremely sensitive to the lateral alignment of the first fiber 201 and the second fiber 202. For a single-mode fiber, even sub-micron misalignment will measurably impact the coupling efficiency. The optical connection 200 is also sensitive to contamination because the beam size at the exposed fiber ends is small. Thus, even micron sized dust particles can measurably degrade the coupling efficiency.

FIG. 8B shows a prior art optical connection 210 with a converging beam and symmetric lenses, which include, for example, PRIZM-MT connectors by USConec. The optical connection 210 has a first fiber 211 and a second fiber 212. The first and second fibers 211, 212 can be similar to those shown in FIG. 8A. The first fiber 211 is part of the first side 224 of the optical connection 210, and the second fiber 212 is part of the second side 225 of the optical connection 210. A gap 219 exists between the two first and second sides 224 and 225.

Beam profiles 214a, 215a, and 218a are shown at three longitudinal positions 214, 215, and 218, respectively. Longitudinal position 214 is the end of the first fiber 211. Longitudinal position 215 is the end of the second fiber 211. Longitudinal position 218 is the optical connection center. The optical connection 210 is symmetric about longitudinal position 218. The beam 208 is shown as it propagates through the optical connection 210. Optical signal 217 is shown propagating from the first fiber 211 to the second fiber 212; however, the propagation direction can be reversed.

In FIG. 8B, only the portion of the first ferrule 220 adjacent to the end of the first fiber 211 is shown, and similarly, only a portion of the second ferrule 221 adjacent to the end of the second fiber 212 is shown.

As the optical signal 217 propagates through the first ferrule 220, the beam 208 expands due to diffraction. At the end surface of the first ferrule, the surface 222 is curved to collimate the beam 208 in the gap between the first ferrule 211 and the second ferrule 212. Because the beam 208 is collimated, the size of the beam 208 is substantially uniform in the gap. The surface 223 is also curved and has substantially the same curvature as the surface 222. Because the surfaces 222, 223 have substantially identical curvatures, they have substantially the same optical power. The beam 208 is focused through the second ferrule 221 until it reaches the end of the second optical fiber 212. The size of the beam 208 at this point substantially matches the beam size for the second fiber 212. This corresponds to the mode matched condition and provides optimal coupling. The optical connection 210 has the disadvantage that the beam 208 can propagate with little divergence for long distances through free space when the second optical connection side 225 is missing, i.e. the optical connection 210 is disconnected.

FIG. 8C shows a prior art optical connection 230 with a converging beam and a single lens. The optical connection 230 has a first fiber 231 and a second fiber 232. The first and second fibers 231, 232 can be similar to those shown in FIGS. 8A and 8B. The first fiber 231 is part of the first side 244 of the optical connection 230, and the second fiber 232 is part of the second side 245 of the optical connection 230. A gap 239 exists between the first and second sides 244 and 245.

Beam profiles 234a, 235a, 236a, 246a, and 249a are shown at five longitudinal positions 234, 235, 236, 246, and 249, respectively. Longitudinal position 234 is the end of the first fiber 231. Longitudinal position 249 is the end of the second fiber 232. Longitudinal position 236 is the optical connection center. The optical connection 230 is symmetric about longitudinal position 236. The beam 238 is shown as it propagates through the optical connection 230. Optical signal 237 is shown propagating from the first fiber 231 to the second fiber 232; however, the propagation direction can be reversed.

In FIG. 8C, only a portion of the first ferrule 240 adjacent to the end of the first fiber 231 is shown, and similarly, only a portion of the second ferrule 241 adjacent to the end of the first fiber 232 is shown. Longitudinal position 235 is the apex of the first ferrule 240. Longitudinal position 246 is the apex of the second ferrule 241.

As the optical signal 237 propagates through the portion of the first ferrule 240, the size of the beam 238 expands due to diffraction. At the end surface of the first ferrule 240, the surface 242 is curved to cause the optical signal 217 in the gap 239 between the first ferrule 240 and the second ferrule 241 to converge, to pass through the focal point forming an intermediate image, and then to diverge. The changing beam size in the gap 239 is shown in the beam profiles 235a, 236a, and 246a. The surface 243 is also curved and has substantially the same curvature as the surface 242. Because the surfaces 242, 243 have substantially identical curvatures, they have substantially the same optical power. The beam 238 is then focused through the second ferrule 241 until it reaches the end of the second optical fiber 232 at longitudinal position 249. The size of the beam 238 at this point substantially matches the beam size for the second fiber 232. This corresponds to the mode matched condition and provides optimal coupling. The optical connection 230 has the disadvantage that the gap 239 is relatively large to accommodate the focal point or intermediate image in the gap 239. The optical connector 230 has the further disadvantage that any dust passing in the gap 239 can pass through the optical signal path, dynamically altering the optical coupling. Dust at or near the longitudinal position 236 is especially problematic because the beam profile 236a is small in this region.

FIG. 8D shows a prior art optical connection 250 with a converging beam and a single lens. The optical connection 250 has a first fiber 251 and a second fiber 252. The first and second fibers 251, 252 can be similar to those shown in FIGS. 8A-8C. The fiber 251 is part of the first side 264 of the optical connection 250, and the fiber 252 is part of the second side 265 of the optical connection 250. A gap 259 exists between the first and second sides 264 and 265.

Beam profiles 254a, 255a, and 258a, are shown at three longitudinal positions 254, 255, and 258, respectively. Longitudinal position 254 is the end of the first fiber 251. Longitudinal position 258 is the end of the second fiber 252. The beam 266 is shown as it propagates through the optical connection 250. Optical signal 257 is shown propagating from the first fiber 251 to the second fiber 252; however, the propagation direction can be reversed.

In FIG. 8D, only a portion of a first ferrule 260 adjacent to the end of the first fiber 251 is shown.

As the optical signal 257 propagates through the first ferrule 260, the beam 266 expands due to diffraction. At the end surface of the first ferrule 260, the surface 262 is curved to cause the beam 266 in the gap 259 between the first side 264 and the second side 265 to converge. Longitudinal position 255 is the apex of a first ferrule 260. The beam 266 is then focused through the gap 259 until it reaches the end of the second fiber 252. The beam size 266 at this point substantially matches the beam size for the second fiber 252. This corresponds to the mode matched condition and provides optimal coupling. The optical connection 250 has the disadvantage that it is sensitive to contamination because the end surface of the second fiber 252 is exposed and the beam profile 258a is small at longitudinal position 258. Thus, even a small dust particle can significantly degrade the coupling efficiency.

FIG. 8E shows an optical connection 270 with a strong and weak lens according to a preferred embodiment of the present invention. The optical connection 270 includes a first fiber 271 and a second fiber 272. The first and second fibers 217, 271 can be similar to those shown in FIGS. 8A-8D. The first fiber 271 is part of the first side 284 of the optical connection 270, and the second fiber 272 is part of the second side 285 of the optical connection 270. A gap 279 exists between the first and second sides 284 and 285.

Beam profiles 274a, 275a, 276a, and 278a are shown at four longitudinal positions 274, 275, 276, and 278, respectively. Longitudinal position 274 is the end of the first fiber 271. Longitudinal position 278 is the end of the second fiber 272. Longitudinal position 275 is the apex of the curved surface 282 that is strongly curved. Longitudinal position 276 is the apex of the curved surface 283 that is weakly curved. Curved surface 282 is located at an end surface of the first ferrule 280. Curved surface 283 is located at an end surface of the second ferrule 281. Longitudinal positions 275 and 276 are separated by the gap 279, which is the spacing between the first and second sides 284 and 285. The beam 286 is shown as it propagates through the optical connection 270. Optical signal 277 is shown propagating from the first fiber 271 to the second fiber 272; however, the propagation direction can be reversed.

The optical power and spacing of the various components of the optical connection 270 can be chosen such that the optical signal 277 traversing the optical connection 270 can be substantially mode matched from the first fiber 271 into the second fiber 272.

Advantages of the optical connection 270 include simultaneously providing an eye-safe beam, increasing contamination resistance, and reducing mechanical tolerances.

Eye safety is achieved by not having collimated beams propagating in free space. That is, neither curved surface 282 nor curved surface 283 collimate a beam emerging from fiber 271 or fiber 272.

Contamination resistance is achieved by making the size of the beam 286 large at both longitudinal positions 275 and 276. For example, if the first fiber 271 and the second fiber 272 are each a 0.2-NA, 50-μm-diameter-core fiber, then the diameter of the beam 286 at the curved surfaces 282 and 283 can be equal to or greater than about 150 μm, which would make the area of the beam 286 on the curved surfaces 282 and 282 at least nine times larger than the area of the beam 286 at longitudinal positions 274 and 278. The resistance to contamination is increased proportionally, or by at least nine times.

In various preferred embodiments the diameter of the beam 286 at the longitudinal positions 275 and 276 is at least twice the diameter of the beam 286 at the end of the fiber, reducing contamination sensitivity by four times. For example, the beam diameter at the longitudinal positions 275 and 276, can be at least 100 μm. Mechanical tolerances can be relaxed because the gap 279 is small and the diameter of the beam 286 is large between the first and second sides 284 and 285. There is no focal point or intermediate image in the gap region allowing this distance to be small, typically on the order of 100 μm, for example. However, the gap 279 can be less than 100 μm. Although the curved surfaces 282 and 283 are shown in FIG. 8E as being both convex, this is not a requirement. Curved surface 282 can be more strongly convex, and curved surface 283 can be concave, for example. Such an arrangement can allow faster expansion of the beam 286 in the gap 279, enhancing eye safety. The optical connection 270 can be arranged to propagate the optical signal 277 in a single direction, from the first fiber 271 to the second fiber 272. It is also possible to reverse the propagation direction.

FIG. 8F shows an optical connection 290 according to a preferred embodiment of the present invention that is similar to the preferred embodiment shown in FIG. 8E but in which the weak lens has zero optical power, i.e., a flat surface. The optical connection 290 has a first fiber 291 and a second fiber 292. The first and second fibers 291, 292 can be similar to those shown in FIGS. 8A-8E. The first fiber 291 is part of the first side 304 of the optical connection 290, and the second fiber 292 is part of the second side 305 of the optical connection 290. A gap 299 exists between the first and second sides 304 and 305.

Beam profiles 294a, 295a, 296a, and 298a are shown at four longitudinal positions 294, 295, 296, and 298, respectively. Longitudinal position 294 is the end of the first fiber 291. Longitudinal position 298 is the end of the second fiber 291. Longitudinal position 295 is the apex of the curved surface 302 that is strongly curved. Curved surface 302 is located at the end surface of the first ferrule 300. Longitudinal position 296 is the flat surface 303 of the second ferrule 301. The flat surface 303 has no optical power. Longitudinal positions 295 and 296 are separated by the gap 299, which is the spacing between the first and second sides 304 and 305. The beam 306 is shown as it propagates through the optical connection 290. Optical signal 297 is shown propagating from the first fiber 291 to the second fiber 292; however, the propagation direction can be reversed.

The optical power and spacing of the various components of the optical connection 290 can be chosen such that the optical signal 297 traversing the optical connection 290 can be substantially mode matched from the first fiber 291 into the second fiber 292.

The distance between the various longitudinal positions 294, 295, 296 and 298 can be readily determined. As an example, if the first fiber 291 has a 50-μm core and 0.2 NA, if the minimum beam diameter on a ferrule end surface is chosen to be at least three times the fiber diameter, i.e., 150 microns, and if the ferrules are made from Ultem™ having a refractive index of 1.65, then the distance of the second ferrule 301 between longitudinal positions 296 and 298 should be approximately 614 μm, for example, to ensure that the beam diameter is 50 μm. This requires a 150-μm beam diameter on the flat surface 303. The gap length 299 can be chosen for convenience, but it is generally desirable to keep this length small. For example, the gap 299 can be set to about 73 μm. For this gap size, the beam diameter at the longitudinal position 295 should be approximately 180 μm. It is desirable to keep the beam size below 250 μm, which is a typical minimum pitch between fibers in an MTP-style connector. A beam diameter less than the pitch is required to avoid insertion loss due to beam clipping.

An advantage of the preferred embodiment shown in FIG. 8F is that no lens features need to be included on the second ferrule, which reduces the manufacturing costs and improves manufacturing yields.

A second advantage of optical connection 290 is that it can be made backward compatible with an existing MTP or similar style connector in which there is no zero power second lens. This is achieved by adjusting the spacing between longitudinal positions 295 and 298. In the example above, this spacing preferably is about 710 μm (=73 μm+637 μm). Without the second ferrule 301, this distance would preferably be reduced to about 513 (=73 μm+440 μm), which in this case would be the gap between the first and second sides 304 and 305. The difference in the gap 299 between the original case, gap 299, and the revised case preferably is about 197 microns, for example. A spacer of this thickness can be included between the first and second sides 304 and 305 to provide the appropriate separation.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An optical connection comprising:
a first lens with a first strength;
a second lens with a second strength weaker than the first strength;
a gap between the first lens and second lens; and
optical fibers that are connected to the first and second lenses and that provide or receive light from the first and second lenses; wherein
no intermediate image is formed; and
a beam of light in the gap region is either diverging or converging.

2. An optical connection of claim 1, wherein the second strength is zero.

3. An optical connection of claim 1, further comprising additional first lenses with the first strength and additional second lenses with the second strength.

4. An optical connection of claim 3, wherein the first lens, the additional first lenses, the second lens, and the additional second lenses are arranged in at least one annular ring.

5. An optical connection of claim 3, wherein the first lens, the additional first lenses, the second lens, and the additional second lenses are arranged in at least one row.

6. An optical connection of claim 5, wherein the first lens, the additional first lenses, the second lens, and the additional second lenses are arranged such that lenses with different strengths alternate along the at least one row.

7. An optical connection of claim 3, wherein:
the first lens and the additional first lenses are arranged in a first array; and
the second lens and the additional second lenses are arranged in a second array adjacent to the first array.

8. An optical connection of claim 3, wherein the first lens, the additional first lenses, the second lens, and the additional second lenses are arranged such that each optical path through the optical connection includes a lens with the first strength and a lens with the second strength.

9. An optical connection comprising:
a first ferrule including a first lens;
a first fiber attached to a first ferrule;
a second ferrule including a second lens; and
a second fiber attached to the second ferrule; wherein
the first and second ferrules, the first and second lenses, and the first and second fibers are configured to provide a first channel that defines a light transmission path; and
an optical power of the first lens is different than an optical power of the second lens.

10. An optical connection of claim 9, wherein:
light emerging from the first fiber is not collimated by the first lens; and
light emerging from the second fiber is not collimated by the second lens.

11. An optical connection of claim 9, wherein a gap between the first lens and the second lens is less than about 100 μm.

12. An optical connection of claim 9, further comprising:
a third fiber attached to the first ferrule; and
a fourth fiber attached to the second ferrule; wherein
the first ferrule further includes an additional second lens;
the second ferrule further includes an additional first lens;
the first ferrule and the second ferrule are identical or substantially identical; and
the first and second ferrules, the additional first and second lenses, and the third and fourth fibers are configured to provide a second channel that defines another light transmission path.

13. An optical connection of claim 12, further comprising keyed, hermaphroditic alignment elements such that the first ferrule and the second ferrule can only be mated in one orientation.

14. An optical connection of claim 12, further comprising additional channels; wherein
each of the additional channels includes lenses of different strengths.

15. An optical connection of claim 12, further comprising:
a gap between the first ferrule and the second ferrule; wherein
an optical signal propagating across the gap has a beam diameter of at least about 100 μm at an end surface of the first ferrule and at an end surface of the second ferrule; and
the beam diameter varies across the gap.

16. A first side of an optical interface comprising:
first lenses with a first strength;
second lenses with a second strength weaker than the first strength; and
optical fibers that are connected to the first and second lenses and that provide or receive light from the first and second lenses; wherein
the first lenses and the second lenses are arranged in a hermaphroditic pattern.

17. A first side of claim 16, wherein the first side includes a ferrule supporting the optical fibers.

18. A first side of claim 17, wherein the ferrule supporting the optical fibers includes hermaphroditic alignment features.

19. A first side of claim 17, wherein the first lenses and the second lenses are formed in the ferrule.

20. A first side of claim 16, wherein, when the first side is rotated by about an axis parallel to a mating direction of the first side, a pattern of the first and second lenses is reversed with a second lens in a location formerly occupied by a first lens and a first lens in a location formerly occupied by a second lens.

21. A first side of claim 20, wherein the rotation is 180°.

22. An optical connection comprising;
a first side of an optical interface as recited in claim 16; and
a second side of the optical interface identical or substantially identical to the first side of the optical interface; wherein
the first and the second sides of the optical interface are mated together.

23. An optical connector comprising the first side as recited in claim 17.

24. An optical connector of claim 23, wherein the ferrule supporting the optical fibers includes hermaphroditic alignment features.

25. An optical connector of claim 23, wherein the first lenses and the second lenses are formed in the ferrule.
